(19) United States
(12) Patent Application Publication
(10) Pub. No.: US 2026/0170689 A1
(43) Pub. Date: Jun. 18, 2026

(54) DYNAMIC PERCEPTION SYSTEM CALIBRATION

(71) Applicant: Deere & Company, Moline, IL (US)

(72) Inventors: Scott N. CLARK, Bettendorf, IA (US); Ashraf QADIR, Ankeny, IA (US); Anand Yogendra PATHAK, West Des Moines, IA (US)

(21) Appl. No.: 18/984,501

(22) Filed: Dec. 17, 2024

(51) Int. Cl. G06T 7/80; G06T 7/20

(52) U.S. Cl. CPC G06T 7/80; G06T 7/20

(57) ABSTRACT

A system includes: a perception system associated with a work machine and configured to capture an image indicative of one or more characteristics; a perception pose actuator controllable to change a pose of the perception sensor during operation of the work machine; one or more processors; and memory storing instructions, executable by the one or more processors. The instructions, when executed by the one or more processors, cause the one or more processors to: execute, during the operation of the work machine and in response to a calibration trigger, a calibration operation to generate a calibration transformation; and control the work machine based, at least, on the calibration transformation and the image.

### FIELD OF THE DESCRIPTION

The present description relates to work machine operations. More specifically, the present description relates to perception sensor systems used in control of work machines, such as agricultural work machines.

### BACKGROUND

There are a wide variety of different types of work machines. Some such work machines include agricultural work machines, such as, but not limited to, agricultural harvesters (e.g., combine harvesters, etc.). A work machine, such as an agricultural work machine, can be controlled during an operation based on sensor data, such as sensor data generated by sensors associated with the work machine. One example of such sensors are perception sensors (e.g., cameras) that generate, as sensor data, one or more images that can be used in the control of the work machine.

The discussion above is merely provided for general background information and is not intended to be used as an aid in determining the scope of the claimed subject matter.

### SUMMARY

A system includes: a perception system associated with a work machine and configured to capture an image indicative of one or more characteristics; a perception pose actuator controllable to change a pose of the perception sensor during operation of the work machine; one or more processors; and memory storing instructions, executable by the one or more processors. The instructions, when executed by the one or more processors cause the one or more processors to: execute, during the operation of the work machine and in response to a calibration trigger, a calibration operation to generate a calibration transformation; and control the work machine based, at least, on the calibration transformation and the image.

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter. The claimed subject matter is not limited to implementations that solve any or all disadvantages noted in the background.

### BRIEF DESCRIPTION OF THE DRAWINGS

FIG. 1 is a partial pictorial, partial schematic illustration showing an example work machine in the form of an agricultural harvester.

FIGS. 2A and 2B are pictorial illustrations showing an example of the agricultural harvester shown in FIG. 1.

FIGS. 3A and 3B are pictorial illustrations showing an example of the agricultural harvester shown in FIG. 1.

FIG. 4 is a block diagram of one example system architecture.

FIG. 5 is a block diagram showing some examples of components of the system architecture, including dynamic perception monitoring system, in more detail.

FIGS. 6A and 6B (collectively referred to herein as FIG. 6) show a flow diagram illustrating one example operation of the system architecture in performing dynamic perception monitoring, calibration, and machine control.

FIG. 7 is a block diagram showing one example of items of a system architecture in communication with a remote server architecture.

FIGS. 8, 9, and 10 show examples of mobile devices that can be used in a system architecture.

FIG. 11 is a block diagram showing one example of a computing environment that can be used in a system architecture.

### DETAILED DESCRIPTION

For the purpose of promoting an understanding of the principles of the present disclosure, reference will now be made to the examples illustrated in the drawings, and specific language will be used to describe the same. It will nevertheless be understood that no limitation of the scope of the disclosure is intended. Any alterations and further modifications to the described devices, systems, methods, and any further application of the principles of the present disclosure are fully contemplated as would normally occur to one skilled in the art to which the disclosure relates. In particular, it is fully contemplated that the features, components, and/or steps described with respect to one example can be combined with the features, components, and/or steps described with respect to other examples of the present disclosure.

As discussed above, operating parameters of a work machine can be controlled, during the operation, based on sensor data generated by sensors associated (e.g., mounted to or otherwise in communication) with the work machine. The sensor data can be utilized by a control system to control one or more operating parameters of the work machine.

One example of such sensors are perception sensors, such as cameras, LiDAR sensors, Radar sensors, as well as other types of perception sensors. The cameras can be of one or more of a variety of types of cameras. Perception sensors generate, as sensor data, one or more images, such as a series of images, which can be utilized in control of the work machine.

In some current systems, perception sensors are hard-mounted or integrated to the work machine at fixed locations, which helps to reduce variability and system error. For example, perception sensors, generally, require calibration to ensure accuracy. Having the perception sensors at fixed locations helps to allow the calibration to be effective throughout the course of an operation. However, there may be a number of reasons to wish to move a perception sensor, such as to change the field of view or to reduce occlusion. Fixed perception sensors are limited in their ability to change field of view or to reduce occlusion, at least relative to moveable perception systems. To provide for multiple fields of view and occlusion reduction, current systems can utilize a greater number of perception sensors placed across the work machine, which can increase costs.

Perception sensors capable of dynamic movement during an operation would provide for greater degree of freedom in changing field of view and in reducing occlusion with less perception sensor systems. However, when a perception sensor is moved from a first pose (e.g., position, orientation, etc.) to a second pose the perception sensor may require calibration to ensure system accuracy (e.g., accurate processing of and value extraction from the generated sensor data (e.g., images)).

Disclosed herein are systems and methods that provide for the dynamic movement and calibration (or recalibration) of perception sensors during the course of an operation. The dynamically moved and recalibrated perception sensors can generate sensor data (e.g., images) to be used in the control of an associated work machine.

It will be understood that while examples herein proceed with reference to work machines in the form of agricultural work machines, such as agricultural harvesters, the systems and methods disclosed herein are applicable to and can be used with a wide variety of other types of work machines, including a wide variety of other types of agricultural work machines.

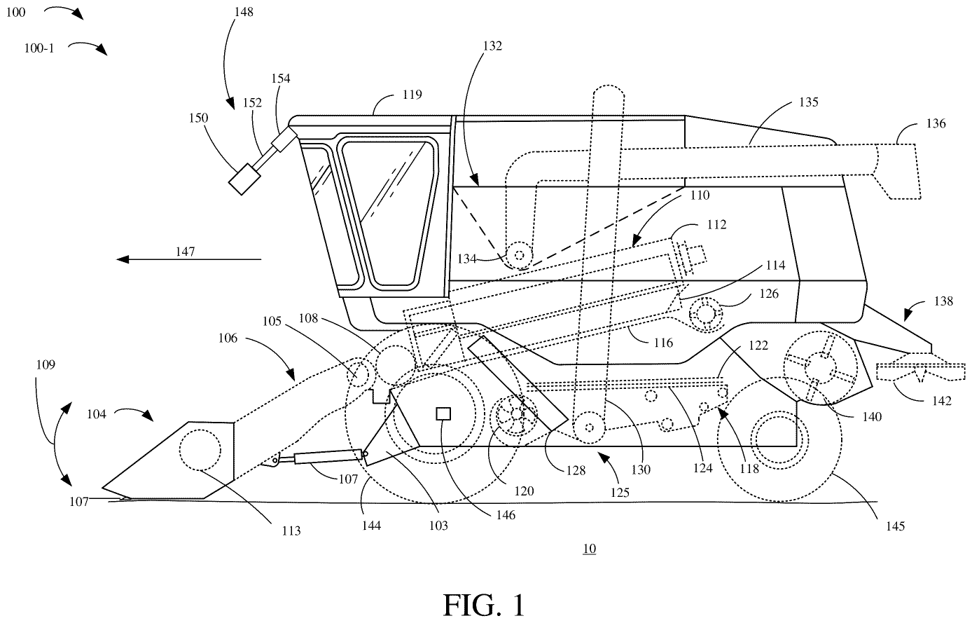

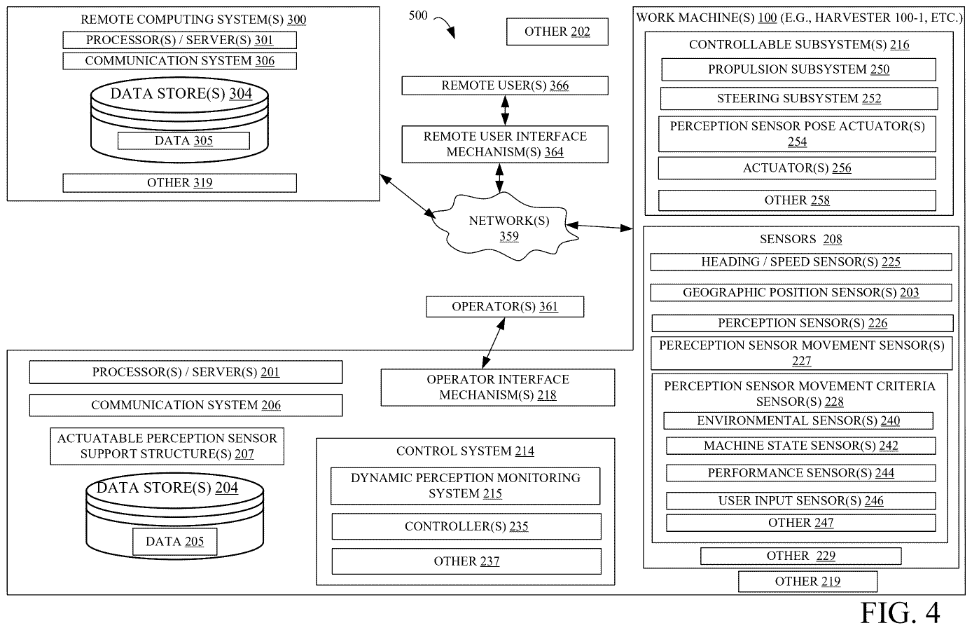

FIG. 1 is partial pictorial, partial schematic illustration of an example agricultural work machine 100 in the form of an agricultural harvester 100-1. In the example shown in FIG. 1, agricultural harvester 100-1 is in the form of a combine harvester. As illustrated in FIG. 1, harvester 100-1 includes ground engaging traction elements (wheels or tracks) 144 and 145 which can be driven by a propulsion subsystem (e.g., internal combustion engine, electric motors, hydrostatic drive, and other drivetrain elements, such as a gear box) to propel harvester 100 across a worksite 10 (e.g., a field). Harvester 100-1 includes an operator compartment or cab 119, which can include a variety of different operator interface mechanisms (e.g., 218 shown in FIG. 4) for controlling harvester 100-1 as well as for presenting (e.g., displaying, etc.) various information. Harvester 100-1 includes a feeder house 106, a feed accelerator 108, and a thresher generally indicated at 110. The feeder house 106 and the feed accelerator 108 form part of a material handling subsystem 125. Header 104 is pivotally coupled to a frame 103 of harvester 100-1 along pivot axis 105. One or more actuators 107 drive movement of header 104 about axis 105 in the direction generally indicated by arrow 109. Thus, a vertical position of header 104 (the header height) above ground 111 over which the header 104 travels is controllable by actuating actuator 107. While not shown in FIG. 1, agricultural harvester 100-1 can also include one or more actuators that operate to apply a tilt angle, a roll angle, or both to the header 104 or portions of header 104.

Material handling subsystem 125 further includes a thresher 110 which illustratively includes a threshing rotor 112 and a set of concaves 114. Further, material handling subsystem 125 also includes a separator 116. Agricultural harvester 100-1 also includes a cleaning subsystem or cleaning shoe (collectively referred to as cleaning subsystem 118) that includes cleaning fan(s) 120, chaffer 122, and sieve 124. The material handling subsystem 125 also includes discharge beater 126, tailings elevator 128, and clean grain elevator 130. The clean grain elevator moves clean grain into a material receptacle (or clean grain tank) 132.

Harvester 100-1 also includes a material transfer subsystem that includes a conveying mechanism 134 and a chute 135. Chute 135 includes a spout 136. In some examples, spout 136 can be movably coupled to chute 135 such that spout 136 can be controllably rotated to change the orientation of spout 136. Conveying mechanism 134 can be a variety of different types of conveying mechanisms, such as an auger, blower, or belted conveyor. Conveying mechanism 134 is in communication with clean grain tank 132 and is driven (e.g., by an actuator, such as motor or engine) to convey material from grain tank 132 through chute 135 and spout 136. Chute 135 is rotatable through a range of positions from a storage position (shown in FIG. 1) to a variety of deployed positions away from agricultural harvester 100-1 to align spout 136 relative to a material receptacle of a material receiving machine that is configured to receive the material within grain tank 132. Spout 136, in some examples, is also rotatable, by an actuator, to adjust the direction of the material stream exiting spout 136.

Harvester 100-1 also includes a residue subsystem 138 that can include chopper 140 and spreader 142.

In some examples, a harvester within the scope of the present disclosure can have more than one of any of the subsystems mentioned above. In some examples, harvester 100-1 can have left and right cleaning subsystems, separators, etc., which are not shown in FIG. 1.

In operation, and by way of overview, harvester 100-1 illustratively moves through a worksite (e.g., field) 10 in the direction indicated by arrow 147. As harvester 100-1 moves, header 104 engages the crop plants to be harvested and cuts, with a cutter bar 107 on the header 104, the crop plants to generate cut crop material.

The cut crop material is engaged by a cross conveyor (e.g. cross auger, belts, etc.) 113 which conveys the severed crop material to a center of the header 104 where the severed crop material is then moved through an opening to a conveyor in feeder house 106 toward feed accelerator 108, which accelerates the severed crop material into thresher 110. The severed crop material is threshed by rotor 112 rotating the crop against concaves 114. The threshed crop material is moved by a separator rotor in separator 116 where a portion of the residue is moved by discharge beater 126 toward the residue subsystem 138. The portion of residue transferred to the residue subsystem 138 is chopped by residue chopper 140 and spread on the field by spreader 142. In other configurations, the residue is released from the agricultural harvester 100-1 in a windrow.

Grain falls to cleaning subsystem 118. Chaffer 122 separates some larger pieces of MOG from the grain, and sieve 124 separates some of finer pieces of MOG from the grain. The grain then falls to a conveyor (e.g., an auger, etc.) that moves the grain to an inlet end of grain elevator 130, and the grain elevator 130 moves the grain upwards, depositing the grain in grain tank 132. Residue is removed from the cleaning subsystem 118 by airflow generated by one or more cleaning fans 120. Cleaning fans 120 direct air along an airflow path upwardly through the sieves and chaffers. The airflow carries residue rearwardly in harvester 100-1 toward the residue handling subsystem 138.

Tailings elevator 128 returns tailings to thresher 110 where the tailings are re-threshed. Alternatively, the tailings also can be passed to a separate re-threshing mechanism by a tailings elevator or another transport device where the tailings are re-threshed as well.

Harvester 100-1 can include a variety of sensors, some of which are illustrated in FIG. 1.

Ground speed sensor 146 senses the travel speed of harvester 100-1 over the ground. Ground speed sensor 146 can sense the travel speed of the harvester 100-1 by sensing the speed of rotation of the ground engaging traction elements 144 or 145, or both, a drive shaft, an axle, or other components. In some instances, the travel speed can be sensed using a positioning system, such as a global positioning system (GPS), a dead reckoning system, a long-range navigation (LORAN) system, a Doppler speed sensor, or a wide variety of other systems or sensors that provide an indication of travel speed. Ground speed sensors 146 can also include direction sensors such as a compass, a magnetometer, a gravimetric sensor, a gyroscope, GPS derivation, to determine the direction of travel in two or three dimensions in combination with the speed. This way, when harvester 100-1 is on a slope, the orientation of harvester 100-1 relative to the slope is known. For example, an orientation of harvester 100-1 could include ascending, descending or transversely travelling the slope.

Harvester 100-1 also includes one or more perception sensor systems 148. Each perception sensor system 148 includes one or more perception sensors 150 (e.g., cameras (e.g., mono cameras, stereo cameras, color (e.g. RGB) cameras, multispectral cameras, thermal cameras, infrared cameras, etc.), LiDAR sensors, Radar sensors, etc.). Perception sensors 150 can illustratively capture one or more images of the worksite 10, the machine 100, or the environment of the worksite 10 and machine 100, to detect one or more corresponding characteristics.

Each perception sensor system 148 further includes an actuatable support structure 152 (e.g., actuatable mounting structure), and one or more actuators 154 (e.g., linear actuator, motor, fluid actuator, etc.) that drive movement of the actuatable support structure 152 and thus, movement of the one or more corresponding perception sensors 150. Actuators 154 are operable to change a pose (height, position, or orientation, or combination thereof) of corresponding one or more perceptions sensors 150. It will be understood that the type of actuator 154 and type of support structure 152 can vary. For example, as illustrated in FIG. 1, support structure 152 comprises a moveable arm (e.g., telescoping arm, robotic arm, etc.), but in other examples, could take other forms or include additional items. For instance, but not by limitation, a tiltable and/or rotatable element that allows for change in orientation (e.g., pitch, roll, yaw) of the perception sensors 150.

While FIG. 1 shows some example mounting locations of perception sensors 150, it will be understood that perception sensors 150 can, alternatively or additionally, be mounted at a variety of other locations on a work machine 100, such as harvester 100-1.

A work machine 100, such as harvester 100-1 as well as other work machines, can include various other sensors, some of which will be described in FIG. 4. A work machine 100, such as harvester 100-1 as well as other work machines, can include various other items, some of which will be described in FIG. 4.

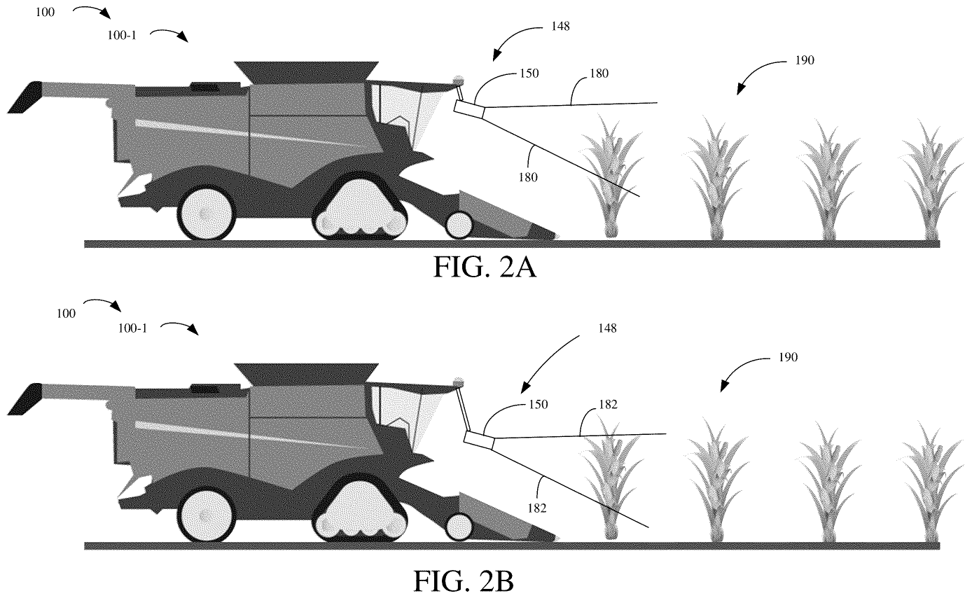

FIGS. 2A and 2B are pictorial illustrations showing an example of changing a pose of a perception sensor 150. As shown in FIG. 2A, perception sensor 150 is in a first pose with a first field of view represented by lines 180. In the illustrated example, perception sensor 150 is generating images of crop 190 to detect characteristics of the crop 190. In FIG. 2B, actuators 154 have been actuated to move perception sensor 150 from the first pose to a second pose (different height than the first pose) with second field of view represented by lines 182. It may be, in the examples shown in FIGS. 2A and 2B, that perception sensor 150 is moved from the first pose to the second pose to account for an obscurant, or to capture better images of ears of the crop plants 190, or to focus on a different characteristic of the crop plants 190, or for a variety of other reasons.

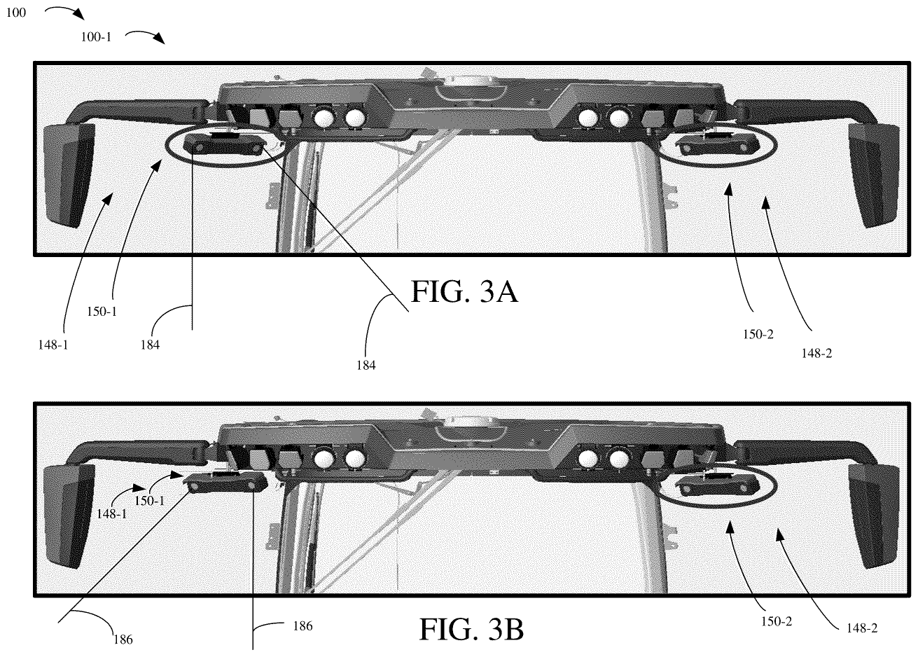

FIGS. 3A and 3B are pictorial illustrations showing an example of changing a pose of a perception sensor 150. As shown in FIG. 3A, work machine 100 (e.g., harvester 100-1) includes a plurality of perception sensor systems 148 (illustratively 148-1 and 148-2). Perception sensor system 148-1 includes a perception sensor 150-1 (illustratively a stereo camera) and perception sensor system 148-2 includes a perception sensor 150-2 (illustratively a stereo camera). As shown in FIG. 3A, perception sensor 150-1 is in a first pose with a first field of view represented by lines 184. In FIG. 3B, actuators 154 have been actuated to move perception sensor 150-1 from the first pose to a second pose (different orientation (e.g., yaw) than the first pose) with second field of view represented by lines 186. It may be, in the examples shown in FIGS. 3A and 3B, that perception sensor 150 is moved from the first pose to the second pose to account for an obscurant, or to generate better (e.g., higher quality) images of a characteristic of interest, or to focus on a different characteristic of interest, or for a variety of other reasons.

FIG. 4 is a block diagram showing one example system architecture 500 (hereinafter also referred to as system 500). Where the work machine 100 comprises an agricultural work machine (e.g., harvester 100-1, etc.), system 500 can also be referred to as an agricultural system. System 500 includes one or more work machines 100. System 500 also includes one or more remote computing systems 300, one or more networks 359, one or more remote user interface mechanisms 364, and can include a variety of other items 202 as well.

Each work machine 100, itself, illustratively includes one or more processors or servers 201, one or more data stores 204, communication system 206, one or more actuatable perception sensor support structures 207, one or more sensors 208, control system 214, one or more controllable subsystems 216, one or more operator interface mechanisms 218, and can include various other items and functionality 219 as well.

Remote computing systems 300, as illustrated, include one or more processors or servers 301, one or more data stores 304, communication system 306, and can include various other items and functionality 319.

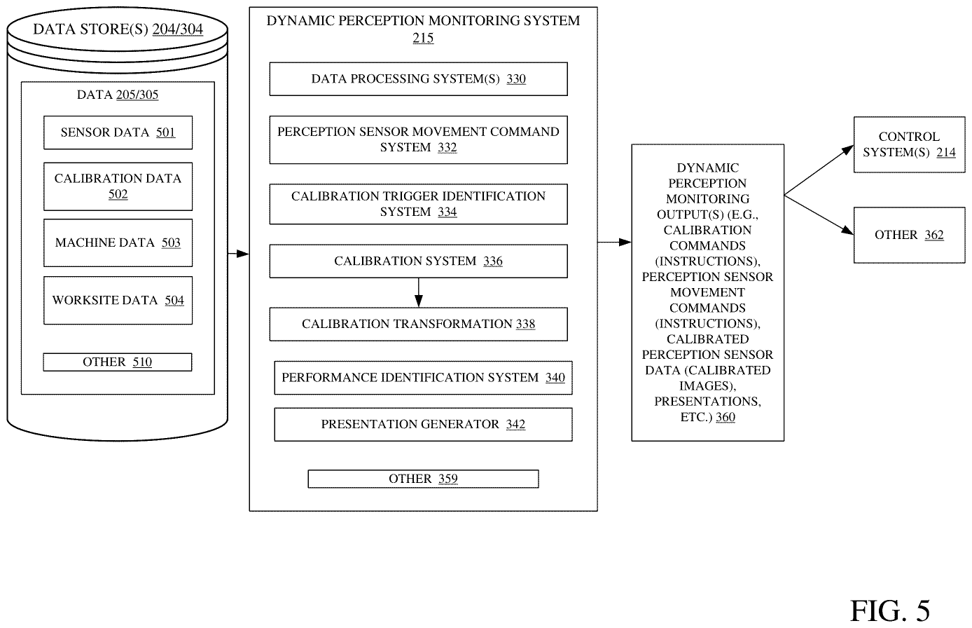

Data stores 204 and data stores 304 each store a variety of data (generally indicated as data 205 and data 305 respectively), some of which will be described in more detail herein. For example, data 205, data 305, or data 405, or a combination thereof, can include, among other things, sensor data, calibration data, machine data, worksite data, as well as various other data including, but not limited to, various other data described herein. Some examples of the various data will be described in more detail in FIG. 5. Additionally, data 205 can include computer executable instructions that are executable by one or more processors or servers 201 to implement other items or functionalities of system 500, including other items or functionalities of work machines 100. Additionally, data 305 can include computer executable instructions that are executable by one or more processors or servers 302 to implement other items or functionalities of system 500, including other items of remote computing systems 300. It will be understood that data stores 204 and data stores 304 can include different forms of data stores, for instance both volatile data stores (e.g., Random Access Memory (RAM)) and non-volatile data stores (e.g., Read Only Memory (ROM), hard drives, solid state drives, etc.).

Actuatable perception sensor support structures 207 comprise actuatable (e.g., moveable) structures for mounting perception sensors 226 to a work machine 100 and for dynamically changing the pose of the perception sensors 226. Actuatable perception sensor support structures 207 are actuatable by operation of perception sensor pose actuators 254. Actuatable perception sensor support structures 207 can comprise a one or more of a moveable arm (e.g., telescoping arm, robotic arm, etc.), a tiltable and/or rotatable element (e.g., a rotatable and orientable mounting platform (e.g., table, etc.)), and other items. In other examples, actuatable perception sensor support structures 207 can take various other forms. Actuatable perception sensor support structures 207 provide for change of pose of perception sensors 226 in one or more degrees of movement. For example, actuatable perception sensor support structures 207 can provide for movement of a perception sensor in three dimensions of a three-dimensional coordinate system (e.g., X, Y, and Z axes), for instance along a Z axis that corresponds to a change in height of the perception sensor 226, along an X axis that corresponds to a change in horizontal position of the perception sensor 226 in a side-to-side plane (e.g. distance from the left side of the machine 100 or the right side of the machine 100 in side-to-side direction), and along a Y axis that corresponds to a change in horizontal position of the perception sensor 226 in a fore-to-aft plane (e.g., further from or closer to the machine 100 in a fore-to-aft direction). In further example, actuatable perception sensor support structures 207 can provide for change of orientation of perception sensors 226, such as a change in one or more of roll, pitch, or yaw. One example of actuatable perception sensor support structures 207 are support structures 152 shown in FIG. 1-3B).

Sensors 208 can include one or more perception sensors 226, one or more heading/speed sensors 225, one or more geographic position sensors 203, one or more perception sensor movement sensors 227, one or more perception sensor movement criteria sensors 228, and can include various other sensors 229 as well. Perception sensor movement criteria sensors 228 can include one or more environmental sensors 240, one or more machine state sensors 242, one or more performance sensors 244, one or more user input sensors 246, and can include various other sensors 247 as well. The sensor data generated by sensors 208 can be communicated to remote computing systems 300 and to other work machines 100.

Control system 214, itself, can include one or more controllers 235 for controlling various other items of a work machine 100, dynamic perception monitoring system 215, and can include other items 237 as well. Controllable subsystems 216 can include propulsion subsystem 250, steering subsystem 252, perception sensor pose actuators 254, actuators 256, and can include various other subsystems 258 as well.

Heading/speed sensors 225 detect a heading characteristic (e.g., travel direction) or speed characteristic (e.g., travel speed, acceleration, deceleration, etc.), or both, of a work machine 100. This can include sensors that sense the movement (e.g., rotation) of ground-engaging elements (e.g., wheels or tracks) or movement of components coupled to the ground engaging elements (e.g., axles) or other elements, or can utilize signals received from other sources, such as geographic position sensors. Thus, while heading/speed sensors 225 as described herein are shown as separate from geographic position sensors 203, in some examples, machine heading/speed is derived from signals received from geographic position sensors 203 and subsequent processing. In other examples, heading/speed sensors 225 are separate sensors and do not utilize signals received from other sources. One example of heading/speed sensors 225 are sensors 146 shown in FIG. 1.

Geographic position sensors 203 illustratively sense or detect the geographic position or location of a work machine 100. Geographic position sensors 203 can include, but are not limited to, a global navigation satellite system (GNSS) receiver that receives signals from a GNSS satellite transmitter. Geographic position sensors 203 can also include a real-time kinematic (RTK) component that is configured to enhance the precision of position data derived from the GNSS signal. Geographic position sensors 203 can include a dead reckoning system, a cellular triangulation system, or any of a variety of other geographic position sensors.

Perception sensors 226 comprise image capture (or generation) mechanisms, such as cameras (e.g., mono cameras, stereo cameras, color (e.g. RGB) cameras, multispectral cameras, thermal cameras, infrared cameras, etc.), LiDAR sensor, Radar sensors, etc. Perception sensors 226 capture (or generate) images of the work machine 100, the worksite (e.g., 10) at which the work machine 100 operates, or of the environment of the work machine 100 or worksite to detect characteristics thereof. The images captured (or generated) by perception sensors 226 indicate the characteristics (and values thereof) and can be used in control of the work machine 100. One example of perception sensors 226 are perception sensors 150 shown in FIGS. 1-3B.

Perception sensor movement sensors 227 generate sensor data indicative of movement of one or more perception sensors 226. Perception sensor movement sensors 227 can be software-based sensors that detect a perception sensor movement command (e.g., control signal) output by control system 214 (e.g., controllers 235), such as perception sensor movement command that controls perception sensor pose actuators 254. Perception sensor movement sensors 227 can be hardware sensors that detect movement of the perception sensors 226, or of items associated with the perception sensors 226 (such as actuators 254 or support structures 207), such as encoders, transducers, potentiometers, as well as a variety of other types of hardware sensors.

Perception sensor movement criteria sensors 228 detect various criteria for driving movement (change of pose) of perception sensors 226. Environmental sensors 240 detect environmental perception sensor movement criteria such as weather characteristics that may affect the performance (e.g., detection or image quality, etc.) of perception sensors 226 such as wind characteristics (e.g., wind speed and direction), ambient light characteristics (e.g., intensity or amount of ambient light, inclination angle of ambient light, etc.), precipitation characteristics (e.g., amount and type of precipitation), temperature, as well as other weather characteristics. It will be noted that, in some examples, at least some weather characteristics can be obtained from sources other than weather sensors, such as from publicly available third-party weather sources (e.g., Internet-based sources), via a communication system (e.g., 206 or 306) over networks 359. Environmental sensors 240 can detect environmental perception sensor movement criteria such as objects or other items at that may act as obscurants to perception sensors 226, such as dust and debris, trees, power lines, components of the work machine 100, as well as various other items at the worksite or in the environment of the worksite. Environmental sensors 240 can detect various other environmental perception sensor movement criteria.

Machine state sensors 242 detect machine state perception sensor movement criteria that may be used in determining whether to move a perception sensor 226 such as detection of auxiliary operations of the work machine 100 (e.g., unloading operation being conducted by material transfer subsystem of harvester 100-1). For instance, it may be desirable or undesirable to move perception sensors 150 while an auxiliary operation is being performed by a subsystem of a work machine 100. Machine state sensors 242 can detect machine state perception sensor movement criteria that may be used in determining whether to move a perception sensor 150 such as detection of positions of components of the work machine 100 (e.g., position or height of header 104 of harvester 100-1). For instance, it may be desirable or undesirable to move perceptions sensors 226 depending on the position of a component of the work machine 100, for example, it may be undesirable to move a perception sensor 226 when doing so may obscure the vision of the perception sensor 226 or cause collision between the perception sensor 226 and the component of the work machine 100 given the position of the component of the work machine 100.

Performance sensors 244 detect machine performance perception sensor movement criteria that may be used in determining whether to move a perception sensor 226 such as one or more performance characteristics of the work machine 100 (e.g., harvester 100-1). For example, with regard to a work machine 100 in the form of a harvester 100-1, the one or more performance characteristics could include yield, crop (e.g., grain) loss, efficiency (e.g., power usage, fuel usage, time to complete, etc.), crop (e.g. grain) cleanliness, as well as a variety of other performance characteristics. It will be understood that the performance characteristics detected by performance sensors 244 can vary with the type of work machine 100. Additionally, it will be understood that the performance characteristics detected by performance sensors 244 may be used in determining whether a perception sensor 226 should be moved, particularly where the perception sensor 226 provides sensor data used in the control of the machine (i.e., generates sensor data that is used in control that affects the performance). For instance, where one or more performance characteristics are satisfactory (e.g., relative to a threshold or desired level), it may be undesirable to move a perception sensor 226, whereas, where one or more performance characteristics are unsatisfactory (e.g., relative to a threshold or desired level), it may be desirable to move a perception sensor 226. When performance is unsatisfactory, moving a perception sensor 226 may provide higher quality sensor data (e.g., higher quality (e.g., less obscured, higher resolution, etc.) sensor data or sensor data that is more useful in improving performance (e.g., sensor data indicative of or more focused on a particular characteristic of interest).

User input sensors 246 detect user input perception sensor movement criteria that may be used in determining whether to move a perception sensor 226, such as user input (or user interaction) with an interface mechanism (e.g., 218, etc.) that commands movement of a perception sensor 226. User input sensors 246 can detect user input (or user interaction) with an interface mechanism (e.g., 218, etc.) that commands movement of a perception sensor 226. User input sensors 246 can be software-based sensors that detect user input (or user interaction) with an interface (such as a touchscreen or microphone) that commands movement of a perception sensor 226. Such user input (or user interaction) can be interaction with a touch screen button that commands movement or provides value(s) or can be interaction with a microphone that audibly commands movement or provides value(s). User input sensors 246 can be hardware sensors that detect user input (or user interaction) that causes movement, change in position, or rotation of an interface mechanism (e.g., 218, etc.) such as a button, knob, lever, or other moveable interface mechanisms that commands movement of a perception sensor 226. Such user input (or user interaction) can be interaction with movable interface mechanisms (e.g., button, knob, lever, etc.) that commands movement or provides value(s).

Perception sensor movement criteria sensors 228 can include various other sensors 247 that detect various other perception sensor movement criteria.

Sensors 208 can also include various other types of sensors 229.

Control system 214 can include one or more controllers 235 (e.g., electronic control units, which can include or be implemented by one or more processors such as one or more processors 201) that generate control signals to control one or more components of a work machine 100 or components of system 500, or both. For example, but not by limitation, controllers 235 can include, a communication system controller to control communication system 206, an interface controller to control one or more interface mechanisms (e.g., 218 or 364, or both), a propulsion controller to control propulsion subsystem 250 to control a travel speed of a work machine 100, a path planning controller to control steering subsystem 252 to control a route or heading of a work machine 100, one or more perception sensor pose actuator controllers to control perception sensor pose actuators 254, and one or more actuator controllers to control operation of actuators 454. In other examples, a central controller 235 can be used to generate control signals to control a plurality of the controllable subsystems 216 as well, in some examples, other items of system 500.

Propulsion subsystem 250 includes one or more controllable actuators (e.g., internal combustion engine, motors, pumps, gear boxes, etc.) that drive the ground engaging traction elements (e.g., wheels or tracks) of a work machine 100 to vary a travel speed of a work machine 100.

Steering subsystem 452 includes one or more controllable actuators (e.g., electric actuators, hydraulic actuators, etc.) that are controllably actuatable to control the steering and thus heading of a work machine 100.

Perception sensor pose actuators 254 can be a variety of different types of actuators that are operable to change a pose (e.g., height, position, orientation, etc.) of perception sensors 226, such as by causing movement of actuatable perception sensor support structures 207. Actuators 254 can include electro-mechanical actuators (e.g., linear actuators) or fluid actuators (e.g., pneumatic, hydraulic, etc.), as well as various other actuators (e.g., motors, etc.). One example of actuators 254 are actuators 154.

Actuators 256 include a variety of different types of actuators that control operating parameters (e.g., pose (e.g., height, position, orientation), speed, spacing, etc.) of one or more components of a work machine 100. Actuators 256 can include actuators that control the position (e.g., height, depth, or spacing from another component of the machine or to the worksite) or orientation (e.g., pitch, roll, yaw, etc.) of components of a work machine 100 as well as actuators that control a speed of movement (e.g., speed of rotation, speed of reciprocation, etc.) of components of a work machine 100. Actuators 256 can include, without limitation, motors, valves, pumps, hydraulic actuators (e.g., hydraulic cylinders, etc.), pneumatic actuators (e.g., pneumatic cylinders, etc.), electro-mechanical actuators (e.g., linear actuators, etc.), as well as various other types of actuators. Where work machine 100 is an agricultural harvester 100-1, actuators 254 can include actuators controllable to control operating parameters of one or more of the components described in FIG. 1.

FIG. 4 also shows that control system 214 can include dynamic perception monitoring system 215. Dynamic perception monitoring system 215 is operable to identify one or more characteristics based on sensor data, control operation (e.g., dynamic movement) of perception sensors 226, and perform in-situ calibration (calibration during the course of the operation of work machine 100) of perception sensors 226. Dynamic perception monitoring system 215 is operable to cause change of pose of one or more perception sensors 226 during the course of the operation of a work machine 100 and to dynamically calibrate (e.g., recalibrate) the one or more perception sensors 226 during the course of the operation of the work machine 100 in response to a change in pose of the one or more perception sensors 226. It will be understood that during the course of the operation of work machine 100, as used herein, corresponds to the work machine 100 being, at least, at a worksite (e.g. field, etc.) and being turned-on, and, in some examples, further corresponds to the work machine 100 being in motion and, in some examples, being in motion and performing a corresponding operation (e.g., harvester 100-1 harvesting). Thus, the systems and methods disclosed herein are operable to dynamically calibrate (e.g., recalibrate) one or more perception sensors 226 during the course of the operation, which can include dynamically calibrating one or more perceptions sensors 226 as the work machine 100 is moving and, in some examples, also while performing a corresponding operation (e.g., harvester 100-1 harvesting). In this way, perception sensors 226 can be dynamically moved and calibrated (recalibrated) during the course of an operation of a work machine 100. Dynamic perception monitoring system 215 will be discussed in more detail in FIG. 5.

Communication system 206 is used to communicate between components of a work machine 100 or with other items of system 500, such as remote computing systems 300, other work machines 100, or user interface mechanisms 364, or a combination thereof. Communication system 306 is used to communicate between components of a remote computing system 300 or with other items of system 500, such as work machines 100, other remote computing systems 300, or user interface mechanisms 364, or a combination thereof.

Communication systems 206 and 306 can each include one or more of wired communication circuitry and wireless communication circuitry, as well as wired and wireless communication components. In some examples, communication systems 206 and 306 can each be a system for communicating over the Internet, a cellular communication system, a system for communicating over a wide area network or a local area network, a system for communicating over a controller area network (CAN), such as a CAN bus, a system for communicating over a controller area network flexible data-rate (CAN-FD), such as a CAN-FD bus, a system for communication over a near field communication network, a system for communicating over ethernet, or a communication system configured to communicate over any of a variety of other networks. Communication systems 206 and 306 can each also include a system that facilitates downloads or transfers of information to and from a secure digital (SD) card or a universal serial bus (USB) card, or both. Communication systems 206 and 306 can each utilize network 359. Networks 359 can be any of a wide variety of different types of networks such as the Internet, a cellular network, a wide area network (WAN), a local area network (LAN), a controller area network (CAN), a controller area network flexible data-rate (CAN-FD), a near-field communication network, ethernet, or any of a wide variety of other networks.

FIG. 4 shows that one or more operators 361 can operate work machines 100. The operators 361 interact with operator interface mechanisms 218. In some examples, operator interface mechanisms 218 can include joysticks, levers, a steering wheel, linkages, pedals, buttons, wireless devices (e.g., mobile computing devices, etc.), dials, keypads, a display device (including a display screen), user actuatable elements (such as icons, buttons, etc.) on a display device, a microphone and speaker (where speech recognition and speech synthesis are provided), among a wide variety of other types of control devices. Where a touch sensitive display system is provided, the operators 361 can interact with operator interface mechanisms 218 using touch gestures. Additionally, at least some of the operator interface mechanisms 218 can be used to present (e.g., display, audible presentation, haptic presentation, etc.) various information. The examples described above are provided as illustrative examples and are not intended to limit the scope of the present disclosure. Consequently, other types of operator interface mechanisms 218 can be used and are within the scope of the present disclosure.

FIG. 4 also shows remote users 366 interacting with work machines 100 and remote computing systems 300 through user interface mechanisms 364 over networks 359. In some examples, user interface mechanisms 364 can include joysticks, levers, a steering wheel, linkages, pedals, buttons, wireless devices (e.g., mobile computing devices, etc.), dials, keypads, a display device (including a display screen), user actuatable elements (such as icons, buttons, etc.) on a display device, a microphone and speaker (where speech recognition and speech synthesis are provided), among a wide variety of other types of control devices. Where a touch sensitive display system is provided, the users 366 can interact with user interface mechanisms 364 using touch gestures. Additionally, at least some of the user interface mechanisms 364 can be used to present (e.g., display, audible presentation, haptic presentation, etc.) various information. The examples described above are provided as illustrative examples and are not intended to limit the scope of the present disclosure. Consequently, other types of user interface mechanisms 364 can be used and are within the scope of the present disclosure.

Remote computing systems 300 can be a wide variety of different types of systems, or combinations thereof. For example, remote computing systems 300 can be in a remote server environment. Further, remote computing systems 300 can be remote computing systems, such as mobile devices, a remote network, a farm manager system, a vendor system, or a wide variety of other remote systems. In one example, work machines 100 can be controlled remotely by remote computing systems 300 or by remote users 366, or both. In some examples, operators 361 are on-board (e.g., in an operator compartment, such as a cab) the work machines 100. In some examples, operators 361 are remote from the work machines 100 and control the work machines 100 through one or more interface mechanisms (e.g. one or more of 218) which are remote from the machines but operatively coupled (e.g., communicatively coupled, such as over networks 359) to the machines.

It will be understood that, in some examples, items in system 500 can be distributed in various ways, including ways that differ from the example shown in FIG. 4. For example, but not by limitation, dynamic perception monitoring system 215, shown in FIG. 4 as being disposed on work machines 100, be located elsewhere, such as at one or more remote computing systems 300. In yet other examples, dynamic perception monitoring system 215 can be distributed across a work machine 100 and a remote computing system 300.

FIG. 5 is a block diagram that shows examples of some of the components of system 500 in more detail and information flow between the components.

As illustrated in FIG. 5, it can be seen that data stores 204 or data stores 304, or a combination thereof, can include as data (205 and 305, respectively), sensor data 501, calibration data 502, machine data 503, worksite data 504, and can include various other data 510, including, but not limited to, other data described elsewhere herein. In some examples, where the data is located can depend on where dynamic perception monitoring system 215 (also called system 215) is located.

As shown in FIG. 5, monitoring system 235 includes one or more data processing systems 330, perception sensor movement command system 332, calibration trigger identification system 334, calibration system 336, performance identification system 340, presentation generator 342, as well as various other items and functionality 359. As will be described in more detail, system 215 is operable to generate one or more monitoring outputs 360.

Sensor data 501 includes sensor data (e.g., images, sensor signals, etc.) generated by sensors 208. Sensor data 501 can include perception sensor data generated by perception sensors 226, perception sensor movement sensor data generated by perception sensor movement sensors 227, geographic position sensor data generated by geographic position sensors 203, heading/speed sensor data generated by heading/speed sensors 225, perception sensor movement criteria sensor data generated by perception sensor movement criteria sensors 228, as well as various other sensor data generated by other sensors 229. Perception sensor movement criteria sensor data can include environmental sensor data generated by environmental sensors 240, machine state sensor data generated by machine state sensors 242, machine performance sensor data generated by performance sensors 244, user input sensor data generated by user input sensors data 246, as well as various other sensor data generated by other sensors 247.

Calibration data 502 can include calibration transformations (e.g., model, matrix, calibration parameters (e.g., sensor parameter values such as intrinsic and extrinsic parameter values, etc.)) used to calibrate perception sensors 226 or, to calibrate sensor data (e.g., images) generated by perception sensors 226. For example, a perception sensor 226 may have a home or default pose for which there is a stored baseline calibration transformation and stored calibration parameters (e.g., sensor parameter values such as intrinsic and extrinsic parameter values)) in calibration data 502. Thus, when the perception sensor 226 is in the home or default pose, the perception sensor 226 (or sensor data (e.g., images) generated thereby) can be calibrated by the stored baseline calibration transformation. When a perception sensor 226 is made to change pose during the operation, a new calibration transformation 338 is generated and stored as calibration data 502 and can be used to calibrate (recalibrate) the perception sensor 226 (or sensor data (e.g., images) generated thereby) in the adjusted pose. Additionally, calibration data 502 can include stored perception sensor parameter values which can be used by calibration system 336 in generating a calibration transformation 338. For example, it may be that some perception sensor parameter values (e.g., intrinsic parameter values) are stored and used as default (rather than recalculated). In another example, depending on the freedom of movement of the perception sensor 226 some extrinsic parameter values can be stored and used as default. For instance, where a perception sensor 226 is moveable in the X, Y, and Z directions but the orientation (α, β, and γ) cannot change, it may be that the (α, β, and γ) are stored and used as default.

Machine data 503 includes data indicative of one or more machine characteristics of the work machines 100. Machine data 506 can include data indicative of the type of machine (e.g. model, etc.), data indicative of the dimensions of the machine, data indicative of locations of components of the machines, machine configuration (e.g., type and characteristics of attachments/implements of the machines), data indicative of ratings of the machine (e.g., machine latency, etc.), as well as various other machine characteristics. Machine data 503 can include identifiers for perception sensors 226 as well as information about the dimensions, movement ranges, mounting locations, home or default pose information, and various other information relative to the perception sensors 226. Machine data 503 can be derived from a variety of sources including, but not limited to, dealer or manufacturer provided information, operator or user input, stored machine identifying information, as well as from a variety of other sources.

Worksite data 504 includes data indicative of attributes of the worksite derived from sources other than sensors 208 or can be derived from sensors 208 during past (historical) operations. As previously mentioned, some data need not be derived from sensors 208. For example, but not by limitation, some perception sensor movement criteria data can be obtained from other sources. For instance, third-party providers can provide environmental data (e.g., weather data). Additionally, operators or users can provide, by input, various data. Further, some data can be obtained from historical data (e.g., data collected during prior operations). For example, but not by limitation, some environmental data (e.g., obstruction data) can be obtained from historical data. The historical data can be obtained from the same machines or from different machines.

Data processing systems process and utilize sensor data 501, calibration data 502, machine data 503, worksite data 504, and other data 510.

For example, data processing systems 330 can process sensor data 501 to generate processed sensor data. The processed sensor data can include computer readable values, useable (or readable) by other items of system 500. Further, data processing systems 330 can utilize calibration data 502 (e.g., calibration transformations) to generate calibrated sensor data, for instance, calibrated images (or values thereof) based on images generated by perception sensors 226 and corresponding calibration transformations.

Data processing system 330 can include various processors or processing functionality, including image processors or processing functionality, sensor signal processors or processing functionality, filtering processors or processing functionality, categorization processors or processing functionality, normalization processors or processing functionality, aggregation processors or processing functionality, color extraction processors or processing functionality, analog-to-digital transformation processors or processing functionality, other transformation processors or processing functionality (e.g., look up tables, equations, mathematical functions, models, etc.), as well as various other data processing processors or processing functionalities.

While data processing system 330 is shown separately from sensors 208, it will be understood that in some examples, sensors 208 can include components of data processing system 330. For example, but not by limitation, a perception sensor 226 can include an image processor or image processing functionality.

It will be understood then that data processing systems 330 can, for example, convert analog signals to readable digital signals (or digital values). It will be understood that data processing systems 330 can, for example, process captured images to extract values (e.g., pixel values, etc.), and can further convert the extracted values. It will be understood that data processing systems 330 can perform pre-processing and post-processing. It will be understood that data processing systems 330 can perform various forms of aggregation on the extracted or converted values. It will be understood that data processing systems 330 can apply calibration transformations to sensor data (e.g., images, etc.) to generate calibrated sensor data (e.g., calibrated images, etc.).

Perception sensor movement command system 332 is operable to determine that a perception sensor 226 should be moved (to change pose of the perception sensor 226) and to generate a perception sensor movement command (instructions) to move the corresponding perception sensor 226 (to change pose of the perception sensor 226) based on one or more items of data 205/305 or based on outputs of other items of system 215 (e.g., performance identification by performance identification system 340). For example, perception sensor movement command system 332 is operable to determine that a perception sensor should be moved based on perception sensor movement criteria detected by perception sensor movement criteria sensors 228, such as one or more of an environmental criteria detected by sensors 240, a machine state criteria detected by sensors 242, a performance criteria detected by sensors 244, a user input detected by sensors 246, or another perception sensor movement criteria detected by sensors 247. In another example, perception sensor movement command system 332 is operable to determine that a perception sensor should be moved based on performance identification by performance identification system 340. Perception sensor movement command system 332 additionally generates perception sensor movement commands (instructions) that can be output (e.g., 360) to control system 214 (e.g., controllers 235) to control perception sensor pose actuators 254 to move (or change poses) of perception sensors 226. A movement command (instructions) can define a new pose to which a perception sensor 226 is to be moved.

Calibration trigger identification system 334 is operable to detect calibration triggers and to generate an output indicative of an identified calibration trigger based on one or more items of data 205/305, based on output movement commands (instructions) generated by perception sensor movement command system 332, based on control signals generated by control system 214, or both. A calibration operation is to be conducted for a perception sensor 226 when the perception sensor 226 changes pose. Thus, calibration trigger identification system 334 is configured to detect, as a calibration trigger, data indicative of a change in pose of a perception sensor 226 (calibration trigger data). Calibration trigger data can include sensor data generated by perception sensor movement sensors 227, commands (e.g., control signals) output by control system 214 (e.g., controllers 235) such as commands (e.g., control signals) provided to perception sensor pose actuators 254, movement commands (instructions) output by perception sensor movement command system 332, or user inputs (e.g., detected by user input sensors 246) commanding movement of perception sensors 226. Calibration trigger identification system 334 generates, in response to detecting a calibration trigger, a calibration trigger output (e.g., signal) indicating the detection of a calibration trigger and, in some examples, identifying the corresponding perception sensor(s) 226.

Calibration system 336 is operable to conduct calibration operations to calibrate (or recalibrate) perception sensors 226 during the course of the operation of a work machine 100 in response to a change in pose (movement) of the perception sensors 226 which can be indicated by a calibration trigger output generated by calibration trigger identification system 334. Calibration system 336 is operable to determine parameters (e.g., intrinsic parameters, extrinsic parameters, etc.) of a perception sensor 226 at a new pose using a calibration algorithm. For example, calibration system 336 is operable to identify extrinsic parameters of a perception sensor 226 at a new pose including a three-dimensional location (X, Y, and Z location) as well as an orientation (α, β, and γ). Thus, calibration system 336 is operable to, in some examples, identify, as the extrinsic parameters, a six-degree vector (X, Y, Z, α, β, and γ) for perception sensor 226 localization. Additionally, calibration system 336 can determine the pose (location and orientation) of the perception sensor 226 relative to a previous pose (or a default or home pose) of the perception sensor 226 or relative to the frame or coordinate system of the machine 100 or relative to a location or pose of another item of the machine (e.g., such as relative to a location or pose of another perception sensor 226 (e.g. such as in the case of LiDAR-Camera calibration or Radar-Camera calibration). Sensor data generated by geographic position sensors 203 (as well as machine data 504) can be used to identify the location of the frame of the machine 100 or the coordinate system of the machine 100 as well as the pose of the perception sensor 226 relative to the frame or the coordinate system.

Additionally, calibration system 336 is operable to determine intrinsic parameters of a perception sensor 226 at a new pose. For example, for perception sensors 226 in the form of cameras, intrinsic parameters can include camera constant (C), x-y scale difference ( [symbol] ) (or focal length in X direction (fx) and focal length in Y (fy), principal point (x_{H}, y_{H}), and sheer parameter (S). Thus, in one example, calibration system 336 is operable to generate a multiple degree of freedom (e.g., eleven degree of freedom) transformation (e.g., Direct Linear Transformation (DLT)) that describes a perception sensor (e.g., camera) model. In addition, calibration system 336 is operable to identify various other parameters, such as other intrinsic parameters, for instance distortion (e.g., lens distortion parameters), In another example, for perception sensors 226 in the form of LIDAR sensors, intrinsic parameters can include range accuracy, angular resolution, laser beam divergence, field of view (FOV), time offset, and intensity correction, In another example, for perception sensors 226 in the form of Radar sensors, intrinsic parameters can include range resolution, angular resolution, Doppler resolution, field of view (FOV), and beamwidth.

With the parameters identified, calibration system 336 is operable to generate a calibration transformation (e.g., a model, a matrix, etc.) which can be used to accurately map a point in the three-dimensional world (imaged by the perception sensor 226) onto a two-dimensional (2D) image plane using an equation such as x=PX, where x is the 2D pixel coordinate, P is the matrix, and X is the 3D world coordinate. The matrix (P) includes the parameters identified by calibration system 336.

Thus, the calibration transformation 338 generated by calibration system 336 can include one or more perception sensor parameters (values thereof) such as extrinsic parameters and intrinsic parameters. Thus, in one example, the calibration transformation 338 can be a model or matrix that includes the various perception sensor parameters (or values thereof), As discussed above, in some examples, some of the perception sensor parameters (extrinsic and/or intrinsic parameters) may be stored (e.g., as calibration data 502) and used as default, rather than being recalculated by calibration system 336. Thus, to identify such parameters, calibration system 336 obtains (e.g., retrieves or receives) the parameters from calibration data 502.

Those skilled in the art will understand that there are a wide variety of perception sensor calibration algorithms and thus, are only discussed briefly herein. All of these various perception sensor calibration algorithms are contemplated herein and can be utilized by calibration system 336. One example of a calibration algorithm is perspective-n-point calibration which can utilize Direct Linear Transformation (DLT), Iterative Closest Point (ICP), and Levenberg-Marquardt optimization, Some example calibration algorithms utilize a calibration object (e.g., object with a known profile or pattern, such as a checkerboard pattern) in the imaged environment to determine parameters. In examples herein, one or more calibration objects could be mounted to 30 the work machine 100 (e.g., header 104 of harvester 100-1) to be captured in images generated by 31 perception sensors 226. In some examples, rather than placing a calibration object on the work machine 100, an object of the work machine 100 could have known coordinates (in a work machine coordinate system) and could be detected (e.g. imaged) by the perception sensor to identify the parameters of the perception sensor. Some example calibration algorithms do not utilize a calibration object or a known object in the scene, such as a self-calibration algorithm. One such example of self-calibration utilizes multiple images and perception sensor motion (e.g., visual odometry) to determine parameters of the perception sensor. Another example calibration algorithm is ground plane calibration which can be utilized to determine parameters of the perception sensor.

In some examples, calibration system 336 can generate calibration commands (instructions) that are utilized by control system 214 (e.g., controllers 235) to control work machine 100 in order to perform calibration. For example, calibration system 336 can generate calibration commands (instructions) that instruct travel speed control which can be utilized by control system 214 (e.g., controllers 235) to generate commands (control signals) to control propulsion subsystem 250 to control a travel speed of work machine 100 (e.g., set to a given speed or bring to a stop), Additionally, or alternatively, calibration system 336 can generate calibration commands (instructions) that instruct travel direction control which can be utilized by control system 214 (e.g., controllers 235) to generate commands (control signals) to control steering subsystem 252 to control a travel direction of work machine 100 (e.g., follow a given path, such as straight path). Additionally, or alternatively, calibration system 336 can generate calibration commands (instructions) that instruct component control which can be utilized by control system 214 (e.g., controllers 235) to generate commands (control signals) to control actuators 256 to control a component of work machine 100. For instance, in one example of component control, calibration commands may instruct that a component (e.g., header 104) of work machine 100 (e.g., harvester 100-1) be positioned to a given setting (e.g., raised to its greatest extent) to be imaged as part of the calibration process.

It will be understood that calibration system 336 can, in performing calibration, utilize various data of data 205/305, for example, but not by limitation, geographic position sensor data generated by geographic position sensors 203.

Additionally, it will be understood that calibration system 336 can utilize multiple calibration algorithms to determine parameters of a perception sensor 226.

As can be seen, calibration system 336 is operable to, in response to a change in a pose of a perception sensor 226, perform calibration and to generate a calibration transformation 338. The calibration transformation 338 is useable by data processing systems 330 (at least some of which can be, in some examples, part of perception sensors 226 as discussed previously) to calibrate perception sensors 226 or to generate calibrated perception sensor data (e.g., calibrated images).

Performance identification system 340 is operable to identify performance, and a change in performance, of a work machine 100 based on one or more items of data 205/305, such as, but not limited to, sensor data 501 (e.g., sensor data generated by performance sensors 244), For example, where performance of the work machine 100 is below a desired level (e.g., target, threshold, etc.) it may be desirable to move a perception sensor 226, particularly where the perception sensor 226 provides sensor data utilized in control that impacts the performance. Additionally, after a perception sensor 226 is moved, performance identification system 340 can identify a performance of the work machine and compare the performance, post-movement, to the performance pre-movement (or compare to a desired level). For example, if movement of a perception sensor 226 results in no better or worse performance than prior to movement, it may be desirable to again move the perception sensor 226. If movement of a perception sensor 226 results in better performance than prior to movement, but still not to a desired level, then it may be desirable to again move the perception sensor 226. In other examples, if a work machine is performing well then it may be undesirable to move a perception sensor 226, even when other perception movement criteria may indicate a need to move the perception sensor 226. Performance identification system 340 is operable to generate performance identification outputs indicative of identified performance and performance comparisons. The performance identification outputs can be provided to or utilized by other items of system 500, including, but not limited to, perception sensor movement command system 332 which can command movement of perception sensors 226 based on the performance identification outputs.

Presentation generator system 342 is operable to generate one or more presentations (e.g., display, audible, haptic etc.) for presentation (e.g., display, audible presentation, haptic presentation, etc.) on one or more interface mechanisms (e.g., one or more of 218 or 364). The 30 presentations can, for example, alert an operator that a perception sensor 226 has changed pose, 31 that calibration (recalibration) has been completed, alert an operator that a perception sensor 226 should be moved (should change pose), as well as various other information. The presentations can, for example, display calibrated image data.

It can be seen that system 215 is operable to generate one or more dynamic perception monitoring outputs 360 (hereinafter also referred to as output/outputs 360). An output 360 can include one or more of perception sensor movement commands (instructions) generated by perception sensor movement command system 332, calibration commands (instructions) generated by calibration system 336, calibrated perception sensor data (calibrated images) generated by data processing systems 330, presentations generated by presentation generator 342, as well as various other items or information generated or identified by system 215. An output 360 can be used in the control of a work machine 100. For example, an output 360 can be obtained (e.g., retrieved or received) by one or more control systems 214 to control a work machine 100, such as by controlling one or more controllable subsystems 216 or one or more interface mechanisms 218 (e.g., to present (e.g., display, etc.) information of (or based on) the output 360), or both. Additionally, or alternatively, an output 360 can be obtained (e.g., retrieved or received) by various other items and used in various other ways. For example, but not by limitation, a harvesting logistics output 360 can be obtained (e.g., retrieved or received) by one or more other items 362, such as one or more interface mechanisms 364 (e.g., to present (e.g., display, etc.) information of (or based on) the output 360).

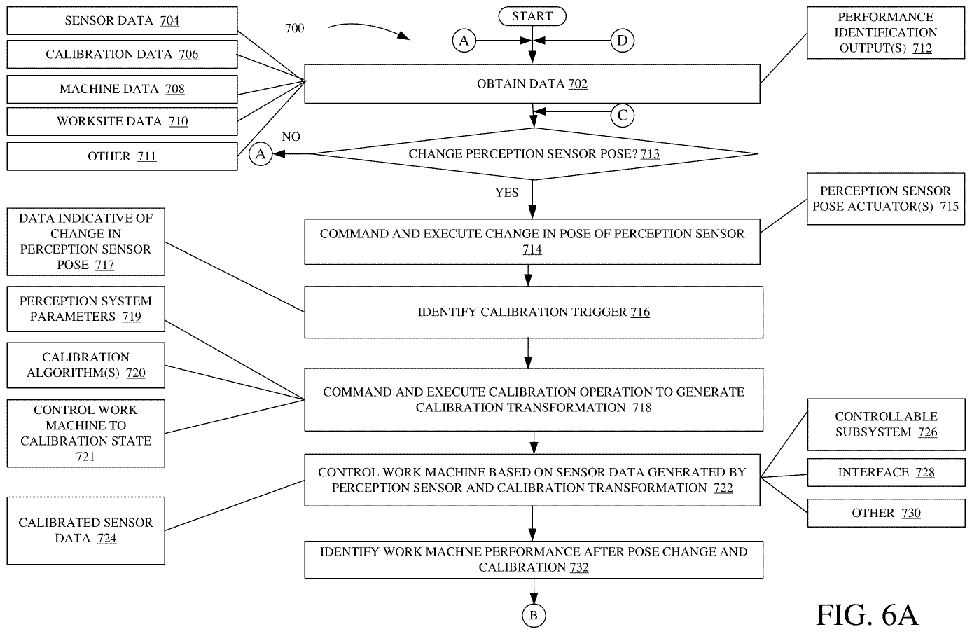

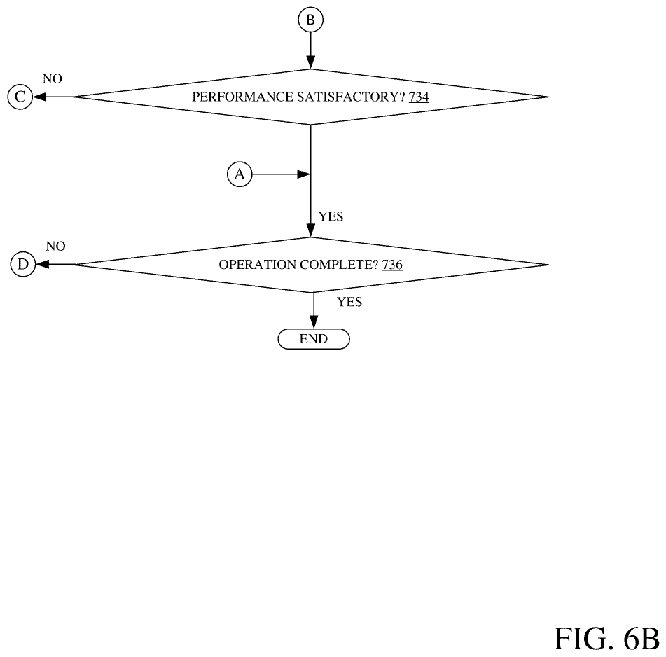

FIGS. 6A and 6B (collectively referred to herein as FIG. 6) show a flow diagram illustrating an example operation 700 of system 500 (e.g., dynamic perception monitoring system 215) in performing dynamic perception sensor monitoring, calibration, and control based thereon. In FIG. 6, it is assumed that the work machine 100 is operating (e.g., is it at least powered on, and may further be at the worksite and may be moving (e.g., traveling)).

At block 702 one or more items of data are obtained (e.g., retrieved or received) by system 500 (e.g., dynamic perception monitoring system 215). The obtained data can include sensor data 501, as indicated by block 704. The obtained data can include calibration data 502, as indicated by block 706, The obtained data can include machine data 503, as indicated by block 708. The obtained data can include worksite data 504, as indicated by block 710. The obtained 29 data can include various other data 510, as indicated by block 711. Additionally, the obtained data 30 can include performance identification outputs generated by system 215 (e.g., performance identification system 340). Further, it will be understood that one or more of the data can be continuously obtained (or updated) throughout operation 700.

At block 713, system 215 (e.g., perception sensor movement command system 332) determines whether to change pose of a perception sensor 226 based, at least, on the data obtained at block 702. Some examples of determining whether to change pose of a perception sensor 226 are discussed previously herein, particularly with reference to FIG. 5. For example, system 215 (e.g., perception sensor movement command system 332) can determine whether to change pose of a perception sensor 226 based on one or more perception sensor movement criteria provided in data 205/305 (e.g., sensor data 501, worksite data 504, etc.) or based on performance identification outputs generated by performance identification system 340, or both. If, at block 713, it is determined that a change in pose is not to occur then, processing returns to block 702 or proceeds to block 736. If, at block 713, it is determined that a change in pose of each one or more perception sensors 226 is to occur then, processing proceeds to block 714.

At block 714, system 215 (e.g., perception sensor movement command system 332) generates perception sensor movement commands (instructions) which are provided to control system 214 (e.g., controllers 235). Control system 214 (e.g., controllers 235) generate commands (e.g., control signals) to control perception sensor pose actuators 254 to move (to change a pose of) a perception sensor 226 based on the perception sensor movement commands (instructions), as indicated by block 715.

At block 716, system 215 (e.g., calibration trigger identification system 334) identifies a calibration trigger. As previously discussed, particularly with reference to FIGS. 4-5, system 215 (e.g., calibration trigger identification system 334) is operable to identify a calibration trigger based on data indicating movement (change of pose) of a perception sensor 226 (e.g., 205/305 (such as sensor data 504 (e.g., from sensors perception sensor movement sensors 227 or user input sensors 246), perception sensor movement commands (instructions) generated by perception sensor movement command system 332, or commands (control signals) generated by control system 214), as indicated by block 718.

At block 718, responsive to the identified calibration trigger, system 215 (e.g., calibration system 336) conducts a calibration operation to calibrate (or recalibrate) perception sensors 226. Some examples of the operation of system 215 (e.g., calibration system 336) are discussed with regard to FIG. 5. As indicated by block 719, system 215 (e.g., calibration system 336) is operable to identify one or more perception senor parameters corresponding to a perception sensor 226 at a new pose, such as intrinsic parameters or extrinsic parameters or a combination thereof. To identify the one or more perception sensor parameters, system 215 (e.g., calibration system 336) executes one or more calibration algorithms, as indicated by block 720. Some examples of calibration algorithms are discussed with regard to FIG. 5. In some examples, system 215 (e.g., calibration system 336) may generate calibration commands (instructions) which can be utilized by control system 214 (e.g., controllers 235) to control work machine 100 in order to perform the calibration operation, as indicated by block 721. Some examples of calibration commands (instructions) and associated machine control are discussed with regard to FIG. 5.

System 215 (e.g., calibration system 336) thus generates a calibration transformation (e.g., 338). The calibration transformation can include one or more perception sensor parameters (values thereof) such as extrinsic parameters and intrinsic parameters. Thus, in one example, the calibration transformation can be a model or matrix that includes the various perception sensor parameters (or values thereof). In some examples, as described above, some perception sensor parameters (values thereof) may be stored in calibration data 502 and used as default and can thus be identified by system 215 by obtaining calibration data 502.

At block 722, system 500 (e.g., control system 214) controls the work machine 100 based, at least, on perception sensor data generated by the perception sensor 226 in the new pose and the calibration transformation. In one example, system 500 (e.g., system 215 (e.g., data processing systems 330) generates calibrated perception sensor data (e.g., calibrated images) based on the calibration transformation, as indicated by block 724. The calibrated sensor data can be used to control the work machine 100. Controlling the work machine 100 can include controlling one or more controllable subsystems 216, as indicated by block 726. Controlling the work machine can, additionally, or alternatively, include controlling one or more interface mechanisms 218, as indicated by block 728. Work machine 100 can be controlled in other ways as well, as indicated by block 730.

At block 732, system 215 (e.g., performance identification system 340) identifies a performance of work machine 100 after movement (change in pose) of the perception sensor 226 based on one or more items of data (e.g., data 205/305 (e.g., sensor data 501, such as performance sensor data generated by performance sensors 244). At block 734, system 215 (e.g., performance identification system 340) identifies whether the performance of the work machine 100 after movement (change in pose) of the perception sensor 226 is satisfactory (e.g., by comparison to performance pre-movement, by comparison to a threshold or target performance, or both). Some examples of the operation of performance identification system 340 are discussed with regard to FIG. 5.

At block 734, if it is determined that performance of the work machine 100 is not satisfactory then, processing returns to block 713 where it will be determined if the pose of the perception sensor 226 should again be changed. If, at block 734, it is determined that performance of the work machine 100 is satisfactory then, processing proceeds to block 736.

At block 736 it is determined if the operation of work machine 100 is complete. If the operation of work machine 100 is complete, then processing returns to block 702. If, at block 736, the operation of work machine 100 is complete, then processing ends.

The present discussion has mentioned processors and servers. In some examples, the processors and servers include computer processors with associated memory and timing circuitry, not separately shown. They are functional parts of the systems or devices to which they belong and are activated by and facilitate the functionality of the other components or items in those systems.

Also, a number of user interface displays have been discussed. The displays can take a wide variety of different forms and can have a wide variety of different user actuatable operator interface mechanisms disposed thereon. For instance, user actuatable operator interface mechanisms can include text boxes, check boxes, icons, links, drop-down menus, search boxes, etc. The user actuatable operator interface mechanisms can also be actuated in a wide variety of different ways. For instance, they can be actuated using operator interface mechanisms such as a point and click device, such as a track ball or mouse, hardware buttons, switches, a joystick or keyboard, thumb switches or thumb pads, etc., a virtual keyboard or other virtual actuators. In addition, where the screen on which the user actuatable operator interface mechanisms are displayed is a touch sensitive screen, the user actuatable operator interface mechanisms can be actuated using touch gestures. Also, user actuatable operator interface mechanisms can be actuated using speech commands using speech recognition functionality. Speech recognition can be implemented using a speech detection device, such as a microphone, and software that functions to recognize detected speech and execute commands based on the received speech.

A number of data stores have also been discussed. It will be noted the data stores can each be broken into multiple data stores. In some examples, one or more of the data stores can be local to the systems accessing the data stores, one or more of the data stores can all be located remote form a system utilizing the data store, or one or more data stores can be local while others are remote. All of these configurations are contemplated by the present disclosure.

Also, the figures show a number of blocks with functionality ascribed to each block. It will be noted that fewer blocks can be used to illustrate that the functionality ascribed to multiple different blocks is performed by fewer components. Also, more blocks can be used illustrating that the functionality can be distributed among more components. In different examples, some functionality can be added, and some can be removed.

It will be noted that the above discussion has described a variety of different systems, generators, controllers, components, and interactions. It will be appreciated that any or all of such systems, generators, controllers, components, and interactions can be implemented by hardware items, such as one or more processors, one or more processors executing computer executable instructions stored in memory, memory, or other processing components, some of which are described below, that perform the functions associated with those systems, generators, controllers, components, or interactions. In addition, any or all of the systems, generators, controllers, components, and interactions can be implemented by software that is loaded into a memory and is subsequently executed by one or more processors or one or more servers or other computing component(s), as described below. Any or all of the systems, generators, controllers, components, and interactions can also be implemented by different combinations of hardware, software, firmware, etc., some examples of which are described below. These are some examples of different structures that can be used to implement any or all of the systems, generators, controllers, components, and interactions described above. Other structures can be used as well.

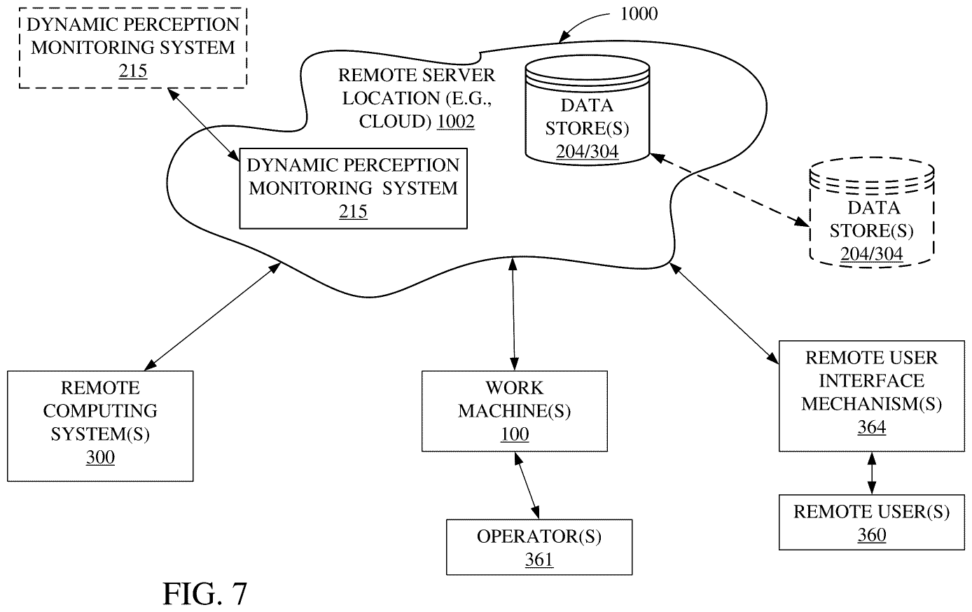

FIG. 7 is a block diagram of a remote server architecture 1000. FIG. 7, also shows one or more work machines 100, one or more remote computing systems 300, and one or more remote user interface mechanisms 364 in communication with the remote server environment. The work machines 100, remote computing systems 300, and remote user interface mechanisms 364 communicate with elements in a remote server architecture 1000. In some examples, remote server architecture 1000 provides computation, software, data access, and storage services that do not require end-user knowledge of the physical location or configuration of the system that delivers the services. In various examples, remote servers can deliver the services over a wide area network, such as the internet, using appropriate protocols. For instance, remote servers can deliver applications over a wide area network and can be accessible through a web browser or any other computing component. Software or components shown in previous figures as well as data associated therewith, can be stored on servers at a remote location. The computing resources in a remote server environment can be consolidated at a remote data center location, or the computing resources can be dispersed to a plurality of remote data centers. Remote server infrastructures can deliver services through shared data centers, even though the services appear as a single point of access for the user. Thus, the components and functions described herein can be provided from a remote server at a remote location using a remote server architecture. Alternatively, the components and functions can be provided from a server, or the components and functions can be installed on client devices directly, or in other ways.

In the example shown in FIG. 7, some items are similar to those shown in previous figures and those items are similarly numbered. FIG. 7 specifically shows that dynamic perception monitoring system 215, data stores 204 or data stores 304, or a combination thereof, can be located at a server location 1002 that is remote from the work machines 100, remote computing systems 300, and remote user interface mechanisms 364. Therefore, in the example shown in FIG. 7, work machines 100, remote computing systems 300, and remote user interface mechanisms 364 access systems through remote server location 1002. In other examples, various other items can also be located at server location 1002, such as various other items of system architecture 500.

FIG. 7 also depicts another example of a remote server architecture. FIG. 7 shows that some elements of previous figures can be disposed at a remote server location 1002 while others can be located elsewhere. By way of example, one or more of data store(s) 204 and 304 can be disposed at a location separate from location 1002 and accessed via the remote server at location 1002. Similarly, dynamic perception monitoring system 215 can be disposed at a location separate from location 1002 and accessed via the remote server at location 1002. Regardless of where the elements are located, the elements can be accessed directly by work machines 100, remote computing systems 300, and remote user interface mechanisms 364 through a network such as a wide area network or a local area network; the elements can be hosted at a remote site by a service; or the elements can be provided as a service or accessed by a connection service that resides in a remote location. Also, data can be stored in any location, and the stored data can be accessed by, or forwarded to, operators, users, or systems. For instance, physical carriers can be used instead of, or in addition to, electromagnetic wave carriers. In some examples, where wireless telecommunication service coverage is poor or nonexistent, another machine, such as a fuel truck or other mobile machine or vehicle, can have an automated, semi-automated or manual information collection system. As a mobile machine (e.g., work machine 100) comes close to the machine containing the information collection system, such as a fuel truck prior to fueling, or other mobile machine or vehicle, the information collection system collects the information from the mobile machine (e.g., work machine 100) using any type of ad-hoc wireless connection. The collected information can then be forwarded to another network when the machine containing the received information reaches a location where wireless telecommunication service coverage or other wireless coverage is available. For instance, a fuel truck, can enter an area having wireless communication coverage when traveling to a location to fuel other machines or when at a main fuel storage location. Other mobile machines or vehicles can enter an area having wireless communication coverage when traveling to other locations or when at another location. All of these architectures are contemplated herein. Further, the information can be stored on a mobile machine (e.g., work machine 100) until the mobile machine enters an area having wireless communication coverage. The mobile machine (e.g., work machine 100), itself, can send the information to another network.

It will also be noted that the elements of previous figures, or portions thereof, can be disposed on a wide variety of different devices. One or more of those devices can include an on-board computer, an electronic control unit, a display unit, a server, a desktop computer, a laptop computer, a tablet computer, or other mobile device, such as a palm top computer, a cell phone, a smart phone, a multimedia player, a personal digital assistant, etc.

In some examples, remote server architecture 1000 can include cybersecurity measures. Without limitation, these measures can include encryption of data on storage devices, encryption of data sent between network nodes, authentication of people or processes accessing data, as well as the use of ledgers for recording metadata, data, data transfers, data accesses, and data transformations. In some examples, the ledgers can be distributed and immutable (e.g., implemented as blockchain).

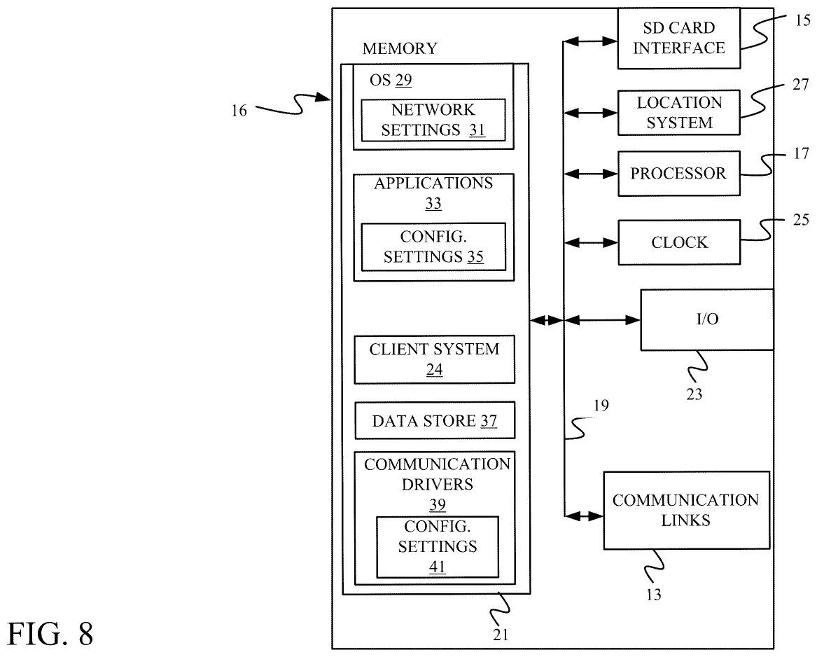

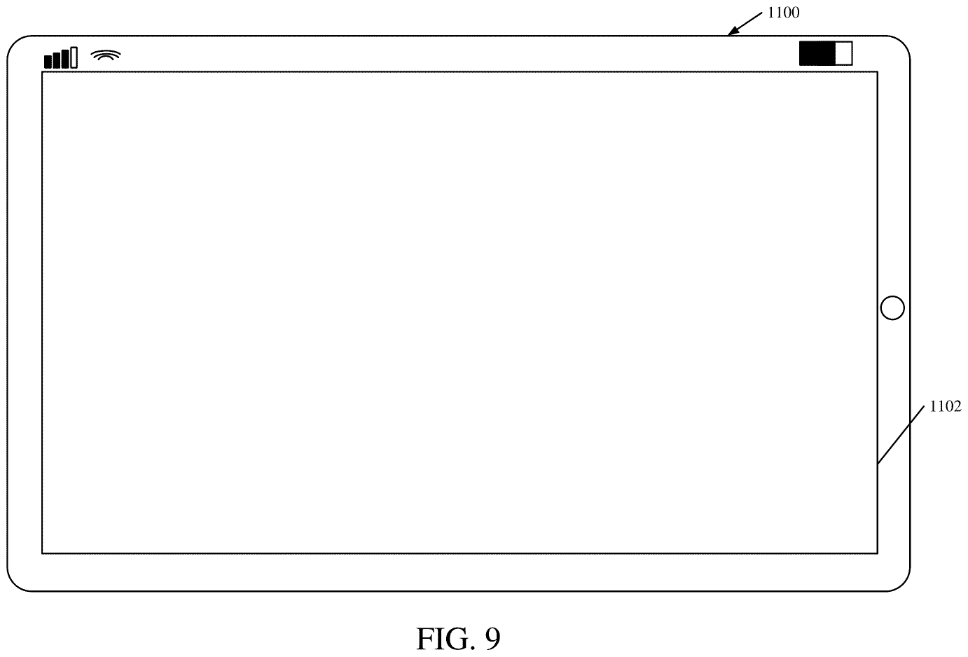

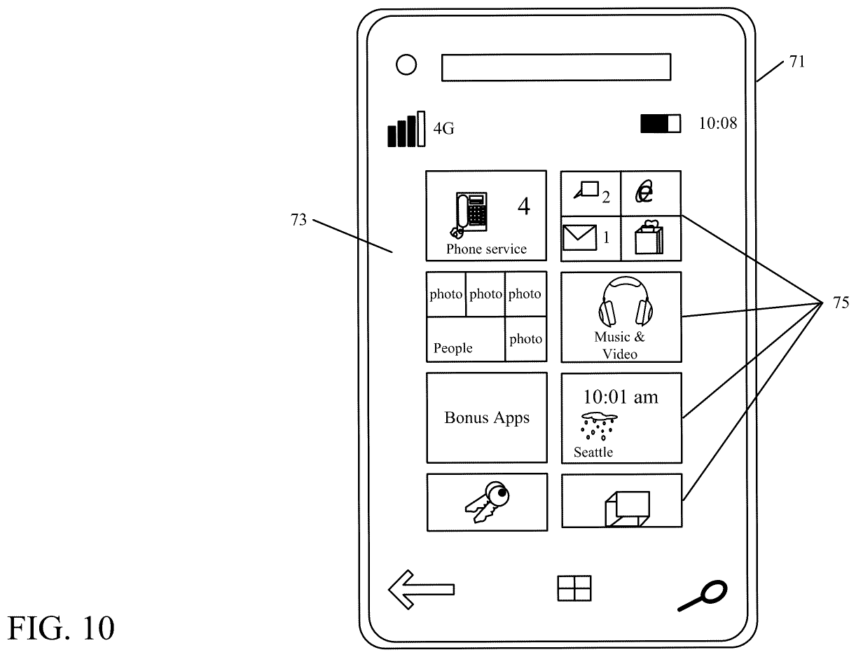

FIG. 8 is a simplified block diagram of one illustrative example of a handheld or mobile computing device that can be used as a user's or client's handheld device 16, in which the present system (or parts of it) can be deployed. For instance, a mobile device can be deployed in the operator compartment of a mobile machine (e.g., work machine 100) or can be communicably coupled to a mobile machine (e.g., work machine 100) for use in generating, processing, or displaying the outputs (e.g., 360) discussed above. FIGS. 9 and 10 are examples of handheld or mobile devices.

FIG. 8 provides a general block diagram of the components of a client device 16 that can run some components shown in previous figures, that interacts with them, or both. In the device 16, a communications link 13 is provided that allows the handheld device to communicate with other computing devices and under some examples provides a channel for receiving information automatically, such as by scanning. Examples of communications link 13 include allowing communication though one or more communication protocols, such as wireless services used to provide cellular access to a network, as well as protocols that provide local wireless connections to networks.

In other examples, applications can be received on a removable Secure Digital (SD) card that is connected to an interface 15. Interface 15 and communication links 13 communicate with a processor 17 (which can also embody processors or servers from other figures) along a bus 19 that is also connected to memory 21 and input/output (I/O) components 23, as well as clock 25 and location system 27.

I/O components 23, in one example, are provided to facilitate input and output operations. I/O components 23 for various examples of the device 16 can include input components such as buttons, touch sensors, optical sensors, microphones, touch screens, proximity sensors, accelerometers, orientation sensors and output components such as a display device, a speaker, and or a printer port. Other I/O components 23 can be used as well.

Clock 25 illustratively comprises a real time clock component that outputs a time and date. It can also, illustratively, provide timing functions for processor 17.

Location system 27 illustratively includes a component that outputs a current geographical location of device 16. This can include, for instance, a global positioning system (GPS) receiver, a LORAN system, a dead reckoning system, a cellular triangulation system, or other positioning system. Location system 27 can also include, for example, mapping software or navigation software that generates desired maps, navigation routes and other geographic functions.

Memory 21 stores operating system 29, network settings 31, applications 33, application configuration settings 35, client system 24, data store 37, communication drivers 39, and communication configuration settings 41. Memory 21 can include all types of tangible volatile and non-volatile computer-readable memory devices. Memory 21 can also include computer storage media (described below). Memory 21 stores computer readable instructions that, when executed by processor 17, cause the processor to perform computer-implemented steps or functions according to the instructions. Processor 17 can be activated by other components to facilitate their functionality as well.

FIG. 9 shows one example in which device 16 is a tablet computer 1100. In FIG. 9, computer 1100 is shown with user interface display screen 1102. Screen 1102 can be a touch screen or a pen-enabled interface that receives inputs from a pen or stylus. Tablet computer 1100 can also use an on-screen virtual keyboard. Of course, computer 1100 can also be attached to a keyboard or other user input device through a suitable attachment mechanism, such as a wireless link or USB port, for instance. Computer 1100 can also illustratively receive voice inputs as well.

FIG. 10 is similar to FIG. 10 except that the device is a smart phone 71. Smart phone 71 has a touch sensitive display 73 that displays icons or tiles or other user input mechanisms 75. Mechanisms 75 can be used by a user to run applications, make calls, perform data transfer operations, etc. In general, smart phone 71 is built on a mobile operating system and offers more advanced computing capability and connectivity than a feature phone.

Note that other forms of the devices 16 are possible.

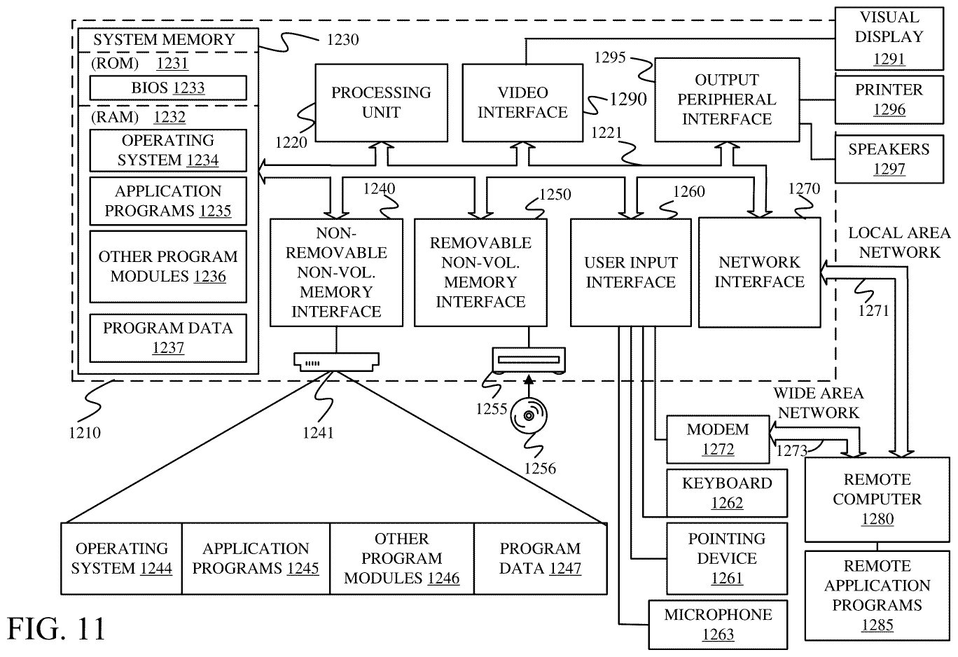

FIG. 11 is one example of a computing environment in which elements of previous figures described herein can be deployed. With reference to FIG. 11, an example system for implementing some embodiments includes a computing device in the form of a computer 1210 programmed to operate as discussed above. Components of computer 1210 can include, but are not limited to, a processing unit 1220 (which can comprise processors or servers from previous figures), a system memory 1230, and a system bus 1221 that couples various system components including the system memory to the processing unit 1220. The system bus 1221 can be any of several types of bus structures including a memory bus or memory controller, a peripheral bus, and a local bus using any of a variety of bus architectures. Memory and programs described with respect to previous figures described herein can be deployed in corresponding portions of FIG. 11.

Computer 1210 typically includes a variety of computer readable media. Computer readable media can be any available media that can be accessed by computer 1210 and includes both volatile and nonvolatile media, removable and non-removable media. By way of example, and not limitation, computer readable media can comprise computer storage media and communication media. Computer storage media is different from, and does not include, a modulated data signal or carrier wave. Computer readable media includes hardware storage media including both volatile and nonvolatile, removable and non-removable media implemented in any method or technology for storage of information such as computer readable instructions, data structures, program modules or other data. Computer storage media includes, but is not limited to, RAM, ROM, EEPROM, flash memory or other memory technology, CD-ROM, digital versatile disks (DVD) or other optical disk storage, magnetic cassettes, magnetic tape, magnetic disk storage or other magnetic storage devices, or any other medium which can be used to store the desired information and which can be accessed by computer 1210. Communication media can embody computer readable instructions, data structures, program modules or other data in a transport mechanism and includes any information delivery media. The term “modulated data signal” means a signal that has one or more of its characteristics set or changed in such a manner as to encode information in the signal.

The system memory 1230 includes computer storage media in the form of volatile and/or nonvolatile memory or both such as read only memory (ROM) 1231 and random access memory (RAM) 1232. A basic input/output system 1233 (BIOS), containing the basic routines that help to transfer information between elements within computer 1210, such as during start-up, is typically stored in ROM 1231. RAM 1232 typically contains data or program modules or both that are immediately accessible to and/or presently being operated on by processing unit 1220. By way of example, and not limitation, FIG. 11 illustrates operating system 1234, application programs 1235, other program modules 1236, and program data 1237.

The computer 1210 can also include other removable/non-removable volatile/nonvolatile computer storage media. By way of example only, FIG. 11 illustrates a hard disk drive 1241 that reads from or writes to non-removable, nonvolatile magnetic media, an optical disk drive 1255, and nonvolatile optical disk 1256. The hard disk drive 1241 is typically connected to the system bus 1221 through a non-removable memory interface such as interface 1240, and optical disk drive 1255 are typically connected to the system bus 1221 by a removable memory interface, such as interface 1250.

Alternatively, or in addition, the functionality described herein can be performed, at least in part, by one or more hardware logic components. For example, and without limitation, illustrative types of hardware logic components that can be used include Field-programmable Gate Arrays (FPGAs), Application-specific Integrated Circuits (e.g., ASICs), Application-specific Standard Products (e.g., ASSPs), System-on-a-chip systems (SOCs), Complex Programmable Logic Devices (CPLDs), quantum computers, etc.

The drives and their associated computer storage media discussed above and illustrated in FIG. 11, provide storage of computer readable instructions, data structures, program modules and other data for the computer 1210. In FIG. 11, for example, hard disk drive 1241 is illustrated as storing operating system 1244, application programs 1245, other program modules 1246, and program data 1247. Note that these components can either be the same as or different from operating system 1234, application programs 1235, other program modules 1236, and program data 1237.

A user can enter commands and information into the computer 1210 through input devices such as a keyboard 1262, a microphone 1263, and a pointing device 1261, such as a mouse, trackball or touch pad. Other input devices (not shown) can include a joystick, game pad, satellite dish, scanner, or the like. These and other input devices are often connected to the processing unit 1220 through a user input interface 1260 that is coupled to the system bus, but can be connected by other interface and bus structures. A visual display 1291 or other type of display device is also connected to the system bus 1221 via an interface, such as a video interface 1290. In addition to the monitor, computers can also include other peripheral output devices such as speakers 1297 and printer 1296, which can be connected through an output peripheral interface 1295.

The computer 1210 is operated in a networked environment using logical connections (such as a controller area network-CAN, local area network-LAN, or wide area network WAN) to one or more remote computers, such as a remote computer 1280.

When used in a LAN networking environment, the computer 1210 is connected to the LAN 1271 through a network interface or adapter 1270. When used in a WAN networking environment, the computer 1210 typically includes a modem 1272 or other means for establishing communications over the WAN 1273, such as the Internet. In a networked environment, program modules can be stored in a remote memory storage device. FIG. 11 illustrates, for example, that remote application programs 1285 can reside on remote computer 1280.

It should also be noted that the different examples described herein can be combined in different ways. That is, parts of one or more examples can be combined with parts of one or more other examples. All of this is contemplated herein.

Although the subject matter has been described in language specific to structural features and/or methodological acts, it is to be understood that the subject matter defined in the appended claims is not necessarily limited to the specific features or acts described above. Rather, the specific features and acts described above are disclosed as example forms of the claims.

What is claimed is:

1. A system comprising:
a perception sensor associated with a work machine and configured to capture an image indicative of one or more characteristics;
a perception pose actuator controllable to change a pose of the perception sensor during operation of the work machine;
one or more processors; and
memory storing instructions, executable by the one or more processors, that, when executed by the one or more processors, cause the one or more processors to:
execute, during operation of the work machine and in response to a calibration trigger, a calibration operation to generate a calibration transformation; and
control the work machine based, at least, on the calibration transformation and the image.

2. The system of claim 1, wherein the instructions, when executed by the one or more processors, cause the one or more processors to identify one or more parameters of the perception sensor based on the calibration operation.

3. The system of claim 1, wherein the one or more parameters include one or more of: (i) one or more extrinsic parameters; or (ii) one or more intrinsic parameters.

4. The system of claim 1, wherein the calibration trigger is indicative of a change in pose of the perception sensor.

5. The system of claim 1, wherein the instructions, when executed by the one or more processors, cause the one or more processors to control perception pose actuator to change the pose of the perception sensor based on criteria.

6. The system of claim 5, wherein the criteria includes one or more of: (i) environmental data; (ii) machine state data; (iii) machine performance data; or (iv) user input data.

7. The system of claim 1, wherein the instructions, when executed by the one or more processors, cause the one or more processors to control the work machine by controlling one or more controllable subsystems of the work machine.

8. The system of claim 1, wherein the instructions, when executed by the one or more processors, cause the one or more processors to control the work machine by controlling one or more interface mechanisms of the work machine.

9. The system of claim 1, wherein the work machine comprises an agricultural harvester.

10. A computer implemented method of controlling a work machine, the computer implemented method comprising:
detecting a calibration trigger associated with a perception sensor corresponding to the work machine;
executing, during the operation of the work machine and in response to the detected calibration trigger, a calibration operation to generate a calibration transformation; and
controlling the work machine based, at least, on the calibration transformation.

11. The computer implemented method of claim 10 and further comprising identifying one or more parameters of the perception sensor based on the calibration operation.

12. The computer implemented method of claim 11, wherein identifying one or more parameters of the perception sensor comprises identifying one or more of: (i) one or more extrinsic parameters of the perception sensor; or (ii) one or more intrinsic parameters of the perception sensor.

13. The computer implemented method of claim 10, wherein detecting the calibration trigger comprises obtaining data indicative of a change in pose of the perception sensor.

14. The computer implemented method of claim 10, wherein controlling the work machine comprises controlling one or more controllable subsystems of the work machine.

15. The computer implemented method of claim 10, wherein controlling the work machine comprises controlling one or more interface mechanisms of the work machine.

16. An agricultural work machine comprising:
a perception sensor configured to capture an image indicative of one or more characteristics;
a perception pose actuator controllable to change a pose of the perception sensor during operation of the work machine;
one or more processors; and
memory storing instructions, executable by the one or more processors, that, when executed by the one or more processors, configure the one or more processors to:
execute, during the operation of the work machine and in response to a calibration trigger, a calibration operation to generate a calibration transformation; and
control the work machine based, at least, on the calibration transformation.

17. The agricultural work machine of claim 16, wherein the instructions, when executed by the one or more processors, configure the one or more processors to identify, based on the calibration operation, one or more of: (i) one or more extrinsic parameters of the perception sensor; or (ii) one or more intrinsic parameters of the perception sensor.

18. The agricultural work machine of claim 16, wherein the calibration trigger is indicative of a change in pose of the perception sensor and comprises one of:
sensor data indicative of detected movement of the perception sensor;
output commands to cause movement of the perception sensor; or
a user input commanding movement of the perception sensor.

19. The system of claim 1, wherein the instructions, when executed by the one or more processors, configure the one or more processors to control the work machine by controlling one or more controllable subsystems of the work machine.

20. The system of claim 1, wherein the instructions, when executed by the one or more processors, configure the one or more processors to control the work machine by controlling one or more interface mechanisms of the work machine.
